(19) United States
(12) Patent Application Publication
(10) Pub. No.: US 2013/0328527 A1
(43) Pub. Date: Dec. 12, 2013

(54) APPARATUS FOR BIDIRECTIONAL ELECTRIC POWER SUPPLY BETWEEN ELECTRIC VEHICLE AND SMART GRID AND METHOD OF BIDIRECTIONALLY SUPPLYING ELECTRIC POWER EMPLOYING THE SAME

(71) Applicant: HYUNDAI MOBIS CO., LTD., Seoul (KR)

(72) Inventor: Jong-Jin KANG, Yongin-si (KR)

(21) Appl. No.: 13/914,517

(22) Filed: Jun. 10, 2013

(30) Foreign Application Priority Data
Jun. 12, 2012 (KR) 10-2012-0062519

(51) Int. Cl. B60L 11/18

(52) U.S. Cl. CPC B60L 11/1809; B60L 11/1838
USPC 320/109; 320/134

(57) ABSTRACT

A bidirectional electric power supplying apparatus comprises a bidirectional charger connected to a smart grid for supplying an electric power to a high-voltage battery of an electric vehicle or supplying the electric power from the high-voltage battery to the smart grid; and a battery management system (“BMS”) controlling a charge of the high-voltage battery and being connected to the bidirectional charger, the BMS controlling the bidirectional charger to supply the electric power from the grid to the high-voltage battery or supply the electric power from the high-voltage battery to the grid. If the mode is set as the smart mode, in consideration of whether the current time is the smart time or the midnight time zone, the electric power is supplied from the high-voltage battery to the grid or supplied from the grid to the high-voltage battery.

### CROSS-REFERENCE(S) TO RELATED APPLICATIONS

This application claims priority to Korean Patent Application No. 10-2012-0062519, filed on Jun. 12, 2012 which is incorporated herein by reference in its entirety.

### BACKGROUND

1. Field

The present disclosure relates to a bidirectional electric power supplying apparatus of an electric vehicle for a smart grid and a method for bidirectionally supplying an electric power employing the same.

2. Description of Related Art

Since an electric vehicle which has been increasingly widely used in recent years is in the early stage of commercialization and associated parts are expensive, as compared with a conventional vehicle provided with an internal combustion engine, an electric vehicle price is extremely high so that there is need to relatively minimize a maintenance cost.

In addition, the electric power cannot meet actively the demand so that, in order to stably supply the electric power, there is a need to move the electric power demand from a peak time zone such as a midday at which the electric power demand is high to a midnight time zone at which there is lower electric power demand.

As the common ground for two necessities mentioned above, the electric vehicle is connected to a smart grid to charge the electric vehicle with the electric power from the grid or to reversely supply the electric power from the electric vehicle to the grid according to the electric power demand. In other words, by integrating the information-communication technology into the established electrical grid, the electric power provider and the consumer exchange bidirectionally the information in real time so that the electric vehicle is connected to the smart grid, which is the next-generation electric power grid and optimizes the energy efficiency, to charge the electric vehicle with the electric power supplied from the grid at midnight time zone at which the electric power demand is low and to reversely supply the electric power from the electric vehicle to the grid, leaving a minimum electric power required for driving the electric vehicle, at the time at which the electric power demand is high. Thus, it is possible to cope actively with the electric power demand.

To achieve the above, a separate grid controlling unit for a grid-charge is provided in the electric vehicle and the electric vehicle is bidirectionally charged by means of the grid controlling unit according to the electric power demand.

By providing the separate grid controlling unit, however, a weight of the electric vehicle is increased; a production cost for the electric vehicle is increased and a fuel efficiency of the electrical vehicle is decreased due to an increased weight of the vehicle.

### SUMMARY

An aspect of the present invention provides a bidirectional electric power supplying apparatus of an electric vehicle for a smart grid, which can control a bidirectional charge between a high-voltage battery and a smart grid through a Battery Management System (BMS), and a method for bidirectionally supplying an electric power employing the same.

In embodiments, a bidirectional electric power supplying apparatus comprises a bidirectional charger connected to the smart grid for supplying an electric power to a high-voltage battery to charge the high-voltage battery provided in the electric vehicle or supplying the electric power from the high-voltage battery to the smart grid; and a battery management system (“BMS”) controlling a charge of the high-voltage battery and being connected to the bidirectional charger, the BMS judging a charging state of the high-voltage battery and whether a current time is a smart time, and controlling the bidirectional charger to supply the electric power from the grid to the high-voltage battery or supply the electric power from the high-voltage battery to the grid.

The BMS may control the bidirectional charger on the basis of a driver's command received from an outside of the vehicle through a communication network.

In the meantime, the BMS may control the bidirectional charger on the basis of a state of a smart switch manipulated by the driver.

In addition, if the BMS directs the bidirectional charger to charge the high-voltage battery, the bidirectional charger may supply the electric power from the grid to the high-voltage battery.

Also, if the BMS directs the bidirectional charger to supply the electric power from the high-voltage battery to the grid, the bidirectional charger may supply the electric power from the high-voltage battery to the grid.

The BMS comprises a BMS control unit determining a control command for the bidirectional charger utilizing a location of the smart switch detected by a smart switch detection unit provided in the BMS or a driver's command received by a command verification unit provided in the BMS and a state of charge (“SOC”) of the high-voltage battery measured by a SOC check unit provided in the BMS, and a BMS communication unit transmitting the control command determined in the BMS control unit, and the bidirectional charger comprises a charger communication unit receiving the control command from the BMS communication unit; a charger control unit processing the control command received by the charger communication unit; a battery charging unit for charging the high-voltage battery with the electric power supplied from the grid in response to a control signal of the charger control unit; and a grid-supplying unit for supplying the electric power from the high-voltage battery to the grid in response to the control signal of the charger control unit. Here, the grid-supplying unit and the battery charging unit are alternatively operated.

A method for bidirectionally supplying an electric power in an electric vehicle for a smart grid in accordance with one aspect of the present invention comprises operating a battery management system (“BMS”) if a bidirectional charger of the electric vehicle is connected to the smart grid; judging whether a current mode is the smart mode if the BMS is operated; judging whether a current time is the smart time if the current mode is judged as the smart mode; judging whether a state of charge (“SOC”) of a high-voltage battery provided in the electric vehicle is greater than the first pre-set value; controlling the bidirectional charger to supply the electric power from the high-voltage battery to the grid if the SOC of the high-voltage battery is greater than the first pre-set value; and judging whether the SOC of the high-voltage battery is less than the second pre-set value and controlling again the bidirectional charger to supply the electric power from the high-voltage battery to the grid if the SOC of the high-voltage battery is greater than the second pre-set value.

The method for bidirectionally supplying the electric power in the electric vehicle for the smart grid in accordance with one aspect of the present invention further comprises, after judging whether the SOC of the high-voltage battery is less than the second pre-set value, judging whether the current time is in a midnight time zone at which a midnight rate is applied, wherein if the current time is judged as the midnight time, the bidirectional charger may supply the electric power from the grid to the high-voltage battery to charge the high-voltage battery.

If the current mode is not judged as the smart mode at the time of judging whether the current mode is the smart mode, the bidirectional charger may supply the electric power from the grid to the high-voltage battery to charge the high-voltage battery.

If the current time is not judged as the smart time at the time of judging whether the current time is the smart time, the bidirectional charger supplies the electric power from the grid to the high-voltage battery to charge the high-voltage battery.

In addition, if the SOC of the high-voltage battery is less than the first pre-set value at the time of judging whether the SOC of the high-voltage battery is greater than the first pre-set value, the bidirectional charger supplies the electric power from the grid to the high-voltage battery to charge the high-voltage battery.

In the meantime, the first pre-set value may be greater than the second pre-set value.

### BRIEF DESCRIPTION OF THE DRAWINGS

FIG. 1 is a block diagram illustrating a structure of a bidirectional electric power supplying apparatus of an electric vehicle for a smart grid in accordance with one embodiment of the present invention;

FIG. 2 is a block diagram showing a control relation between a battery management system and a bidirectional charger in the bidirectional electric power supplying apparatus of the electric vehicle for the smart grid in accordance with one embodiment of the present invention; and

FIG. 3 is a flow chart illustrating a method for bidirectionally supplying the electric power in the electric vehicle for the smart grid in accordance with one embodiment of the present invention.

### DESCRIPTION OF EMBODIMENTS

Exemplary embodiments of the present invention will be described below in more detail with reference to the accompanying drawings. The present invention may, however, be embodied in different forms and should not be construed as limited to the embodiments set forth herein. Rather, these embodiments are provided so that this disclosure will be thorough and complete, and will fully convey the scope of the present invention to those skilled in the art. Throughout the disclosure, like reference numerals refer to like parts throughout the various figures and embodiments of the present invention.

The drawings are not necessarily to scale and in some instances, proportions may have been exaggerated in order to clearly illustrate features of the embodiments.

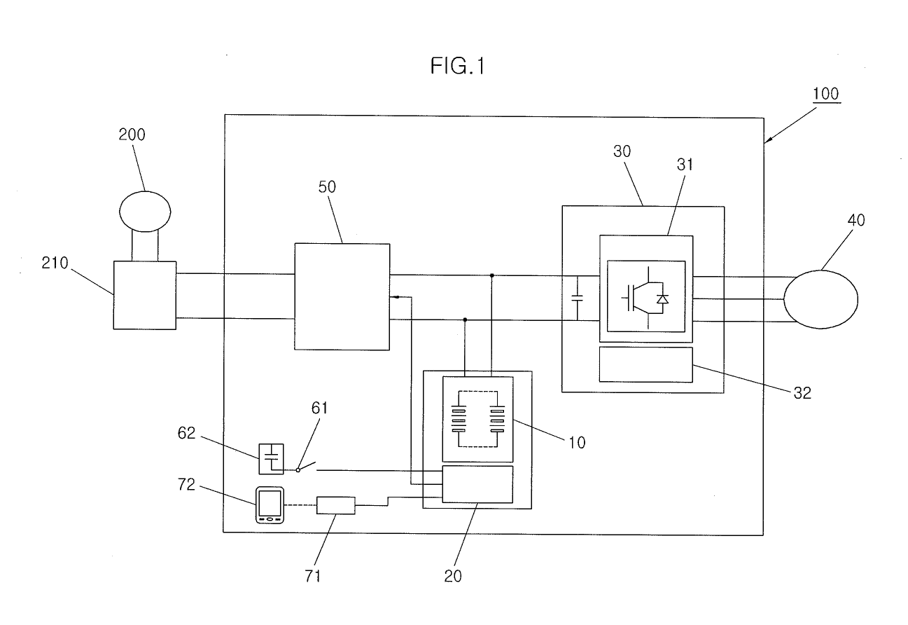

FIG. 1 illustrates a bidirectional electric power supplying apparatus of an electric vehicle for a smart grid in accordance with one embodiment of the present invention.

The bidirectional electric power supplying apparatus of the electric vehicle for the smart grid in accordance with one embodiment of the present invention comprises a high-voltage battery 10, a bidirectional charger 50 for charging the high-voltage battery 10 or for supplying the electric power from the high-voltage battery 10 to a grid 200 if the bidirectional charger is connected to the grid 200 and a battery management system (“BMS”) 20 for controlling the bidirectional charger 50.

The electric power required for driving an electric vehicle 100 is charged in the high-voltage battery 10. The direct current electric power charged in the high-voltage battery 10 is converted into the alternating current electric power by a motor control unit 30 including an inverter 31 and an inverter control unit 32 and is then supplied to a driving motor 40 generating a driving force.

The BMS 20 measures conditions such as a state of charge (“SOC”), a temperature and the like of the high-voltage battery 10 to control a charge of the high-voltage battery 10.

The bidirectional charger 50 is connected to the grid 200 to supply the electric power from the grid 200 to the high-voltage battery 10 for charging the high-voltage battery 10 or to supply the electric power from the high-voltage battery 10 to the grid 200.

In the meantime, as shown in FIG. 1, the bidirectional charger 50 is controlled by the BMS 20.

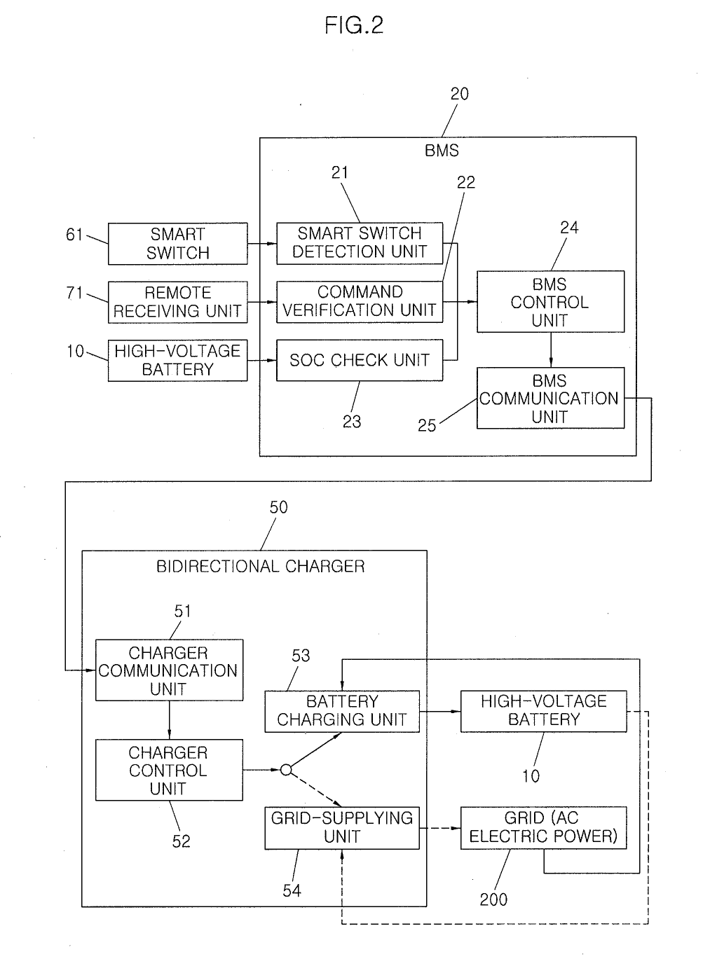

In particular, the structure of the BMS 20 for controlling the bidirectional charger 50 is illustrated with reference to FIG. 2. The BMS 20 comprises a smart switch detection unit 21 for recognizing an operation of a smart switch through which a driver can operate arbitrarily the bidirectional charger 50 in the smart mode, a command verification unit 22 verifying the driver's command received through a communication, a SOC check unit 23 measuring the SOC of the high-voltage battery 10, a BMS control unit 24 determining whether to control the bidirectional charger 50 on the basis of the information received from the smart switch detection unit 21, the command verification unit 22 and the SOC check unit 23, and a BMS communication unit 25 communicating with the bidirectional charger 50.

The smart switch detection unit 21 and the command verification unit 22 are provided for turning ON/OFF an operation of the bidirectional charger 50 in the smart mode. The smart mode means the state in which the electric power of the high-voltage battery 10 is supplied to the grid 200 at the time zone in which an electric rate is expensive when the SOC of the high-voltage battery 10 is sufficient. Therefore, when the bidirectional charger 50 is operated in the smart mode, the bidirectional charger performs basically a charge of the high-voltage battery 10. However, in the smart mode operation condition, that is, in the smart time and if the SOC satisfies the condition which exceeds a standard, the bidirectional charge 50 supplies the electric power (which is charged in the high-voltage battery 10) from the high-voltage battery 10 to the grid 200.

The smart switch detection unit 21 detects a state of the smart switch 61 provided between an auxiliary battery 62 and the BMS 20 in the electric vehicle 100 to allow the bidirectional charger 50 to be operated in the smart mode according to ON/OFF of the smart switch 61.

On the sidelines of the smart switch 61, the command verification unit 22 is provided for remotely receiving the driver's command to operate the bidirectional charger 50 in the smart mode on the basis of the driver's command. The command verification unit receives the driver's command, which is received by a remote communication such as a wireless internet or a Bluetooth, through a terminal unit 72 such as a smart phone to allow the bidirectional charger 50 to be operated in the smart mode.

The SOC check unit 23 measures a charging state of the high-voltage battery 10, that is, the SOC (state of charge) of the high-voltage battery 10, and utilizes it for determining the charging direction of the bidirectional charger 50.

The BMS control unit 24 judges and determines the charging direction of the bidirectional charger 50 on the basis of the information received from at least one of the smart switch detection unit 21, the command verification unit 22 and the SOC check unit 23. Here, the charging direction means an operation state of the bidirectional charger 50. In the other words, the charging direction indicates a state in which the bidirectional charger 50 supplies the electric power from the grid 200 to the high-voltage battery 10 to charge the high-voltage battery or a state in which the bidirectional charger supplies the electric power from the high-voltage battery 10 to the grid 200.

The control command determined in the BMS control unit 24 for the bidirectional charger 50 is transmitted to the bidirectional charger 50 via the BMS communication unit 25.

The bidirectional charger 50 comprises a charger communication unit 51 receiving the control command from the BMS 20, a charger control unit 52 processing the control command received by the charger communication unit 51, and a battery charging unit 53 and a grid supplying unit 54 which are alternatively operated according to a processing result of the charger control unit 52.

The charger communication unit 51 receives the control command from the BMS communication unit 25 and transmits it to the charger control unit 52.

The charger control unit 52 processes the control command transmitted from the charger communication unit 51 and the bidirectional charger 50 is operated according to the charging direction determined in the charger control unit 52. That is, if the BMS 20 directs the charger control unit 52 to charge the high-voltage battery 10, the charger control unit 52 operates the battery charging unit 53 of the bidirectional charger 50 to supply the electric power from the grid 200 to the high-voltage battery 10 for charging the high-voltage battery. In addition, if the BMS 20 directs the charger control unit 52 to supply the electric power from the high-voltage battery 10 to the grid 200, the charger control unit 52 operates the grid supplying unit 54 of the bidirectional charger 50 to supply the electric power from the high-voltage battery 10 to the grid 200.

The battery charging unit 53 and the grid supplying unit 54 are alternatively operated.

By controlling integrally the separate smart bidirectional charger 50 in the BMS 20 as described above, it is possible to reduce the required parts so that a weight of the vehicle and a production cost can be reduced.

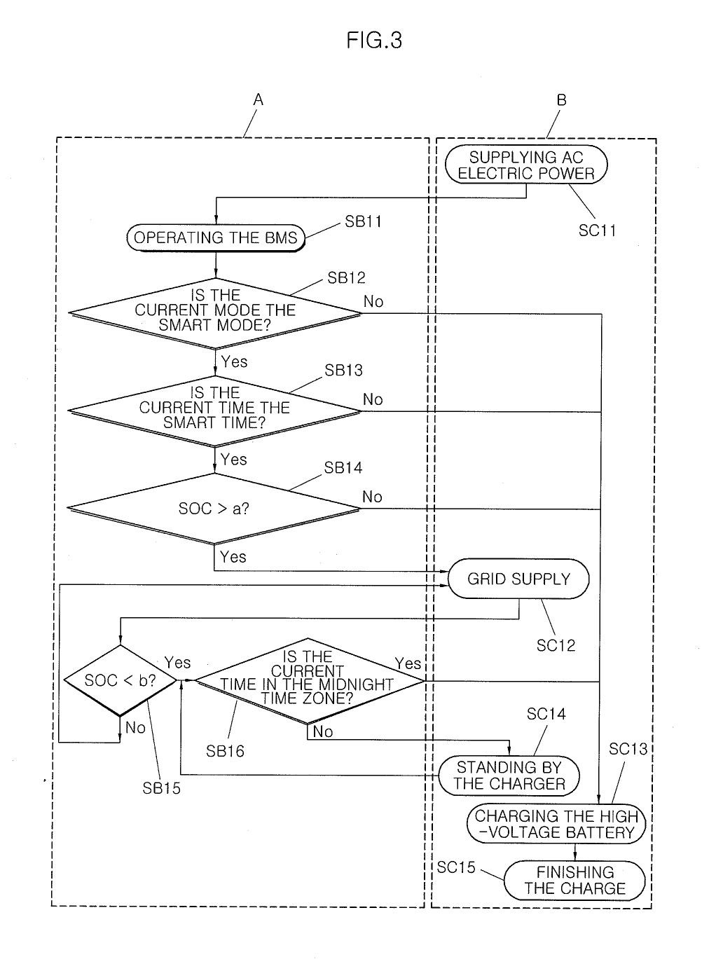

In the meantime, the method for bidirectionally supplying the electric power in the electric vehicle for the smart grid is illustrated with reference to FIG. 3.

According to the method for bidirectionally supplying the electric power in the electric vehicle for the smart grid according to one embodiment of the present invention, the BMS 20 controls the bidirectional charger 50 to control the method for supplying the electric power, the procedures indicated by “A” in FIG. 3 are carried out in the BMS 20, and the procedures indicated by “B” in FIG. 3 are carried out in the bidirectional charger 50.

First of all, if the bidirectional charger 50 of the electric vehicle 100 is connected to the grid 200, the BMS 20 is operated (SB11). By the operation of the BMS 20, the BMS 20 controls an operation of the bidirectional charger 50 to charge the high-voltage battery 10 or supply the electric power from the high-voltage battery 10 to the grid 200.

If the BMS 20 is operated, the BMS judges whether the smart mode is selected (SB12). In the smart mode judging step (SB12), the BMS judges whether the driver selects the smart mode, through the smart switch detection unit 21 or the command verification unit 22.

If the BMS 20 judges that the driver selects the smart mode, a smart time judgment step SB13 for judging whether the current time is the smart time is carried out. The smart time means the time at which an electric rate is relatively expensive. By supplying the electric power charged in the high-voltage battery 10 to the smart grid 200 at the smart time, the electric rate can be calculated through a watt-hour meter 210. In other words, the electric power is supplied from the high-voltage battery 10 of the electric vehicle to the grid 200 at the smart time, and the electric power is supplied from the grid 200 to the high-voltage battery 10 at the midnight time zone.

A watt-hour according to the electric power supplying direction can be measured by the watt-hour meter 210 to calculate the electric rate.

As described above, after verifying that the driver selects the smart mode and the current time is the smart time, the BMS verifies whether the sufficient electric power is charged in the high-voltage battery 10. The BMS checks the SOC of the high-voltage battery 10 to judge whether the SOC of the high-voltage battery 10 exceeds the first pre-set value (a). Supplying the electric power from the high-voltage battery 10 to the grid 200 means a discharge of the high-voltage battery 10, and the discharge of the high-voltage battery is carried out only when the SOC of the high-voltage battery 10 is high. Basically, the electric power should be charged in the electric vehicle 100 over the certain SOC to drive the electric vehicle. The BMS judges whether the SOC of the high-voltage battery 10 exceeds the first pre-set value (a) which is the pre-set value at which the electric power is not supplied to the high-voltage battery 10 to the grid 200 due to an insufficient charge of the high-voltage battery under the certain SOC. In other words, if the SOC of the high-voltage battery 10 is less than the first pre-set value “a”, since the sufficient electric power is not charged in the high-voltage battery 10, the bidirectional charger cannot supply the electric power from the high-voltage battery 10 to the grid 200. In the meantime, the sufficient electric power is charged in the high-voltage battery 10 and the SOC exceeds the first pre-set value “a”, a grid supplying step SC12 in which the high-voltage battery discharges the electric power and supplies the electric power to the grid 200 through the bidirectional charger 50 is carried out.

During the grid supplying step (SC12), the BMS checks periodically the SOC of the high-voltage battery 10. The BMS checks the SOC of the high-voltage battery 10 to judge whether the SOC of the high-voltage battery 10 is less than the second pre-set value “b” (SB15). If the SOC of the high-voltage battery 10 is greater than the second pre-set value “b”, the grid supplying step SC12 is continuously carried out, otherwise, the BMS verifies whether the current time is in the midnight time zone at which a midnight rate is applied (SB16).

Here, the second pre-set value “b” is less than the first pre-set value “a”.

If the current time is in the midnight time zone at which the midnight rate is applied, the BMS 20 controls the bidirectional charger 50 to supply the electric power from the grid 200 to the high-voltage battery 10 for charging the high-voltage battery (SC13). If the current time is not in the midnight time zone which the midnight rate is applied, the BMS stands by (SC14) and then judges again whether the current time is in the midnight time zone after certain time (SB16).

In addition, if the selected mode is not judged as the smart mode in the smart mode judgment step SB12, if the current time is not judged the smart time in the smart time judgment step SB13 or if the SOC of the high-voltage battery 10 is less than the first pre-set value “a” in the charge state judgment step SB14, the BMS 20 controls the bidirectional charger 50 to supply the electric power in the grid 200 to the high-voltage battery 10 for charging the high-voltage battery 10 (SC13).

As illustrated above, if the electric power is supplied from the grid 200 to the high-voltage battery 20 and a charge of the high-voltage battery begins, the BMS 20 measures the SOC of the high-voltage battery 10 and halts a charge process for the high-voltage battery when the high-voltage battery is fully charged (SC15).

According to the bidirectional electric power supplying apparatus of the electric vehicle for the smart grid in accordance with one embodiment of the present invention having the structure illustrated as above and the method for bidirectionally the electric power employing the same, the bidirectional charge between the smart grid and the high-voltage battery can be performed by means of the battery management system without a separate grid control unit so that it is possible to reduce structural elements required for the bidirectional charge of the electric vehicle utilizing the smart grid.

As illustrated above, as the number of parts to be mounted in the electric vehicle is decreased, a reduction effect of cables, a reduction effect of weight of the electric vehicle and a reduction of production costs are accompanied, and a fuel efficiency of the electric vehicle can be enhanced due to a reduction of the vehicle's weight.

While embodiments of the present invention have been described, it will be apparent to those skilled in the art that various changes and modifications may be made without departing from the spirit and scope of the invention as defined in the following claims.

What is claimed is:

1. A bidirectional electric power supplying apparatus of an electric vehicle, comprising;
a bidirectional charger configured to be connected to a smart grid, configured to supply electric power from the smart grid to a high-voltage battery to charge the high-voltage battery provided in the electric vehicle, and further configured to supply an electric power from the high-voltage battery to the smart grid; and
a battery management system (“BMS”) configured to control charge of the high-voltage battery and connected to the bidirectional charger, the BMS being configured to judge a charging state of the high-voltage battery and determine whether a current time is a smart time or not, and further configured to control the bidirectional charger to supply electric power either from the grid to the high-voltage battery or from the high-voltage battery to the grid based on the determination.

2. The apparatus of claim 1, wherein the BMS is configured to control the bidirectional charger on the basis of a driver's command received from a device outside the vehicle through a communication network.

3. The apparatus of claim 1, wherein the BMS is configured to control the bidirectional charger on the basis of a state of a smart switch manipulated by the driver.

4. The apparatus of claim 1, wherein if the BMS directs the bidirectional charger to charge the high-voltage battery,
the bidirectional charger configured to supply the electric power from the grid to the high-voltage battery.

5. The apparatus of claim 1, wherein if the BMS directs the bidirectional charger to supply the electric power from the high-voltage battery to the grid,
the bidirectional charger configured to supply the electric power from the high-voltage battery to the grid.

6. The apparatus of claim 1,
wherein the BMS comprises a BMS control unit configured to determine a control command for the bidirectional charger utilizing a state of the smart switch detected by a smart switch detection unit provided in the BMS or a driver's command received by a command verification unit provided in the BMS and a state of charge (“SOC”) of the high-voltage battery measured by a SOC check unit provided in the BMS, and
a BMS communication unit configured to transmit the control command determined in the BMS control unit, and
wherein the bidirectional charger comprises a charger communication unit configured to receive the control command from the BMS communication unit;
a charger control unit configured to process the control command received by the charger communication unit;
a battery charging unit configured to charge the high-voltage battery with the electric power supplied from the grid in response to a control signal of the charger control unit; and,
a grid-supplying unit configured to supply the electric power from the high-voltage battery to the grid in response to the control signal of the charger control unit, the grid-supplying unit and the battery charging unit being alternatively operated.

7. A method of bidirectionally supplying electric power between an electric vehicle and a smart grid, comprising;
operating a battery management system (“BMS”) if a bidirectional charger of the electric vehicle is connected to the smart grid;
determining whether a current mode is the smart mode or not if the BMS is operated;
determining whether a current time is the smart time if the current mode is determined as the smart mode;
determining whether a state of charge (“SOC”) of a high-voltage battery provided in the electric vehicle is greater than the first pre-set value;
controlling the bidirectional charger to supply electric power from the high-voltage battery to the grid if the SOC of the high-voltage battery is greater than the first pre-set value; and
determining whether the SOC of the high-voltage battery is less than the second pre-set value and controlling again the bidirectional charger to supply electric power from the high-voltage battery to the grid if the SOC of the high-voltage battery is greater than the second pre-set value.

8. The method of claim 7,
further comprising, after determining whether the SOC of the high-voltage battery is less than the second pre-set value, determining whether the current time is in a midnight time zone at which a midnight rate is applied,
wherein if the current time is determined as the midnight time, the bidirectional charger supplies electric power from the grid to the high-voltage battery to charge the high-voltage battery.

9. The method of claim 7,
wherein, if it is determined that the current mode is not the smart mode at the time of determining whether the current mode is the smart mode, the bidirectional charger supplies the electric power from the grid to the high-voltage battery to charge the high-voltage battery.

10. The method of claim 7,
wherein, if it is determined that the current time is not the smart time at the time of judging whether the current time is the smart time, the bidirectional charger supplies the electric power from the grid to the high-voltage battery to charge the high-voltage battery.

11. The method of claim 7,
wherein, if the SOC of the high-voltage battery is less than the first pre-set value at the time of judging whether the SOC of the high-voltage battery is greater than the first pre-set value, the bidirectional charger supplies the electric power from the grid to the high-voltage battery to charge the high-voltage battery.

12. The method of claim 7,
wherein the first pre-set value is greater than the second pre-set value.
